(19) United States
(12) Patent Application Publication
(10) Pub. No.: US 2026/0027500 A1
(43) Pub. Date: Jan. 29, 2026

(54) FILTER LAYER

(71) Applicant: Filtrox AG, St. Gallen (CH)

(72) Inventors: Reto MÜHLEMANN, St. Gallen (CH); Clemens STUDER, Arosa (CH); Dennis HAAG, Grabs (CH); Brian FRANK, St. Gallen (CH)

(73) Assignee: Filtrox AG, St. Gallen (CH)

(21) Appl. No.: 18/997,135

(22) PCT Filed: Jul. 14, 2023
(86) PCT No.: PCT/EP2023/069598

§ 371 Date: Jan. 20, 2025

(30) Foreign Application Priority Data
Jul. 19, 2022 (EP) 22185589.3

(51) Int. Cl. B01D 39/18; B01J 20/24; B01J 20/28; C12H 1/056

(52) U.S. Cl. CPC B01D 39/18; B01J 20/24; B01J 20/28004; B01J 20/28023; B01J 20/28028; C12H 1/0424; B01D 2239/0407; B01D 2239/1225; B01D 2239/1233; B01D 2239/1241

(57) ABSTRACT

A filter layer containing a fibrous matrix and an adsorbent embedded in the fibrous matrix for the targeted removal of substances that impair taste, in particular from wine, as well as a filter system with the filter layer, a use of the filter layer, a process for manufacturing the filter layer and a process for removing phenols from wine. The filter layer contains a fibrous matrix, preferably with cellulose fibres, and an adsorbent embedded in the matrix. The adsorbent has a weight percentage between 15% and 60%. The adsorbent contains cellulose ester particles, preferably cellulose acetate propionate particles, at least 80% of the particles having a diameter of less than 200 um. Alternatively or additionally, the adsorbent contains cellulose ester fibres, preferably cellulose acetate fibres, at least 80% of the fibres having a length of 0.5-5 mm, and a largest external diameter of 10 μm to 200 μm.

The invention relates to a filter layer comprising a fibrous material matrix and an adsorbent embedded in the fibrous material matrix for the targeted removal of substances that impair taste, in particular from wine, as well as a filter system with such a filter layer, a use of such a filter layer, a process for producing such a filter layer and a process for removing phenols from wine.

Filter layers are known for a wide range of applications in a wide variety of compositions.

Filter sheets, which are used primarily for solid/liquid separation, generally have a cellulose fibre matrix made from plant-based cellulose. Filter aids are incorporated into the cellulose fibre matrix to cope with demanding filtration tasks. These are usually kieselguhr, perlite, activated carbon and/or PVPP.

In wine production, an uncontrolled off-flavour caused by volatile phenols is a particularly serious problem. Volatile phenols, especially 4-ethylphenol (‘4-EP’) and 4-ethylguaiacol (‘4-EG’), are formed when grapes are contaminated with Brettanomyces or Dekkera yeasts. The taste is reminiscent of ink, glue, horse sweat, leather or stables and can be described as a mould taste, Brett taste or ‘mould taste’. The yeasts are found in all wine-growing regions, but are more prevalent in warmer regions.

The development of Brettanomyces can be limited by adding sulfur dioxide or chitosan during maturation and clarification. However, the Brettanomyces population can remain viable. Alternatively or additionally, a steam treatment, an ozone treatment, a second toasting or an ultrasonic treatment of the wooden barrels in which the wine is to be aged can be carried out.

Larcher, Puecher, Rohregger, Malacarne and Nicolini have published in Food Chemistry 132 (2012) 2126-2130 that the content of 4-EP and 4-EC in wine is reduced by the addition of cellulose acetate (CA), cellulose acetate propionate (CAP) or cellulose propionate (CP) fibres. For this purpose, up to 20 g/l of the fibres were left in a contaminated red wine for 60 minutes. At a dose of 4 g/1, the phenolic content is reduced by up to 40%. The fibres must be removed from the wine and can be regenerated.

WO2020041253 A1 discloses a filter article comprising cellulose ester staple fibres, for example cellulose acetate and cellulose acetate propionate, which can provide an improved drainage rate. The filter article can have a small pore size and can also be used to filter wine. A depletion of volatile phenols is not shown.

The object of the invention is therefore to avoid the disadvantages of the known material, in particular to provide a filter layer, a filter system and a process which enable the rapid, selective and cost-effective removal of substances which impair taste, in particular phenols, from fluid compositions, in particular from wine.

The task is solved by a filter layer containing a fibrous matrix and an adsorbent embedded in the fibrous matrix for the targeted removal of substances that impair taste from fluid media, in particular from wine, a filter system with such a filter layer, a use of such a filter layer, a method for producing such a filter layer, and a method for removing phenols with such a filter layer, according to the independent patent claims.

In the context of the invention, a filter layer is understood to mean a structure, in particular a flat structure, through which a fluid medium can be passed while unwanted components such as solids and/or, in particular, flavours and/or odours present in solution are separated. Preferably, it is a depth filter layer with a thickness of at least 1 mm. Alternatively, filter membranes are also conceivable.

In the context of the invention, filter layers, in particular flat, pre-assembled filter sheets, are produced, for example, from processed celluloses with incorporated fillers.

The filter layer comprises a fibrous material matrix which ensures a defined three-dimensional cohesion of the filter layer in the dry state. This may be a fibrous material matrix, preferably with fibres made of cellulose, which may be fixed by a conventional wet-strength agent, for example PAAE resins.

The fibrous material matrix serves as a mechanical framework for the filter layer, in which filter aids are arranged.

An adsorbent is embedded in the fibrous material matrix.

The fluid medium can be passed through the filter layer, leaving the adsorbent in the filter layer.

The adsorbent has a weight fraction between 10% and 60%, preferably between 20% and 35%.

The adsorbent contains cellulose ester particles, in particular cellulose acetate ester particles, preferably cellulose acetate propionate particles, or consists of these.

Alternatively, the adsorbent may comprise cellulose acetate, cellulose acetate butyrate or cellulose propionate particles.

At least 80% of the particles have a diameter of less than 300 μm, preferably less than 200 μm, more preferably less than 100 μm.

Preferably, at least 80% of the particles have a diameter greater than 5 μm, preferably greater than 10 μm. The diameter of the particles is understood to mean the grain size or the equivalent diameter, which can be determined, for example, by sieving.

Alternatively or in addition, the adsorbent contains or consists of cellulose ester fibres, preferably cellulose acetate fibres.

Alternatively, the adsorbent may contain cellulose acetate propionate, cellulose acetate butyrate or cellulose propionate fibres.

At least 80% of the fibres have a length of 0.5-5 mm, preferably 1-3 mm, and a maximum external diameter of 10 μm to 200 μm, preferably 20 μm to 100 μm. The external diameter is understood to be the diameter in a direction perpendicular to the longitudinal extension of the fibre.

In the case of hollow fibres, at least 80% of the fibres have a maximum external diameter of 10 μm to 200 μm. In the case of solid fibres, at least 80% of the fibres have a maximum external diameter of 2 μm to 100 pm.

In a fibre with a circular cross-section, the external diameter is the same in all directions perpendicular to the longitudinal extension of the fibre and thus corresponds to the largest external diameter. As a rule, the cross-sections of the fibres are not circular. The largest external diameter is therefore used as the reference value.

Typically, the external diameter varies little over the longitudinal expansion of the fibre. The largest external diameter can be used as a reference value.

It has been shown that filter layers with an adsorbent as described above are homogeneous and durable. In particular, cellulose ester fibres can be uniformly and permanently embedded in a filter matrix.

A homogeneous filter layer has a constant ability to remove substances that impair taste, both along its surface and along its three-dimensional structure. In particular, volatile phenols such as 4-EP and 4-EG can be removed.

Homogeneous filter layers can be customised after production, for example by punching or high-pressure water cutting, to the desired filter cross-section.

The filter layers are also durable to a certain degree, so that they can be passed through by a large amount of fluid medium and/or multiple times without the adsorbent dissolving from the fibrous matrix. With such filter layers, for example, 500-600 litres of liquid medium can be filtered in a typical filter system.

At the same time, there is sufficient flow around the adsorbent in the filter layer to ensure that a significant proportion of the substances that impair taste, in particular 4-EP and 4-EG, are removed.

The thickness of the filter layer can be 1.5-6 mm, in particular 3.5-4.5 mm. Filter layers of this thickness provide a fibrous matrix depth that offers sufficient support for the embedded adsorbent and in which a sufficient amount of adsorbent is present, while also remaining easy to process.

The surface weight of the filter layer, for example, is 1000-1800 g/m², in particular 1300-1500 g/m².

The water value or the flow rate of the filter layer can be 50-600 l/(m²*min), in particular 150-500 l/(m²*min), at a differential pressure of 1 bar. The water value or the flow rate indicate the permeation of pure water through the layer and form a specification for a quality control of the layers.

The water value is thus a measure of the permeate performance of the filter layer.

The adsorbent preferably contains cellulose ester hollow fibres, preferably cellulose acetate hollow fibres. Hollow fibres offer a comparatively large total surface area due to the presence of an outward and an inward-facing surface. Since the adsorbing effect occurs mainly on the surface, a particularly high level of effectiveness is given.

The largest inner diameter of the hollow fibre is preferably between 40% and 80% of the largest outer diameter.

The hollow fibres do not have to have a round cross-section or a constant wall thickness. Therefore, the largest inner diameter and the largest outer diameter are used as reference values.

The size ratios mentioned allow the fluid flowing through the fibres to reach the inside of the hollow fibres, and the surface inside the hollow fibre provides a significant proportion of the total surface area of the hollow fibre.

The filter layer can contain other ingredients, such as diatomaceous earth, perlite, wet strength agents and/or aluminosilicate.

Perlite is a mineral rock formed by volcanic activity. Kieselguhr is a fossilised mineral of plant origin. Perlite and kieselguhr can be used as filter aids in the filtration of liquids in the food industry. Together with the fibrous matrix, the filter aids prevent solids from the flowing fluid from clogging the filter or getting into the filtrate.

Wet strength agents increase the strength of the filter layer. To prevent the bonds between the fibres from being dissolved by water, wet strength agents are added during production to create new covalent bonding elements between the fibres. Important wet strength agents include resins based on polyamidoamine epichlorohydrin (PAAE), melamine formaldehyde (MF) or urea formaldehyde (HF).

The filter layer may also contain an aluminosilicate as an additional adsorbent, also known as zeolite, in particular an aluminium silicate with a hollow structure. For example, it is known from EP07103040 A1 that zeolite can bind 2,4,6-trichlo-roanisole, but is essentially unable to bind other desirable flavourings in the wine. In addition to the undesirable taste caused by phenols, a filter layer as described above that also contains aluminosilicate can reduce cork taint.

The adsorbent, particularly in the form of cellulose ester fibres, can have a fibre weight greater than 3 den, particularly greater than 20 den.

Cellulose ester hollow fibres are usually manufactured with a fibre weight of more than 20 denier.

It has been shown that cellulose ester fibres with a fibre weight of more than 3 denier are very good at binding phenols.

It would also be conceivable to carry out a precoat filtration, in which an adsorbent, as described above, is added to the fluid medium to be filtered and a carrier layer with a fibrous matrix, as described above, is flowed against. The adsorbent and the substances removed remain in the fibrous matrix.

According to the invention, a filter system has at least one filter element that has at least one filter layer as described above. Filter elements usually have clear elements and cloudy elements, between which at least one filter layer is attached. The filter elements can have openings through which the unfiltrate can be fed to the filter layers and openings through which the filtrate is discharged.

Filter elements can be arranged in a filter system so that the flow can pass through several filter elements in parallel. It can also be arranged so that the flow passes through the filter elements in series.

According to the invention, a filter layer as described above is used to remove phenols from wine contaminated with Brettanomyces. The wine can flow through the filter layer, for example in a filter system as described above, whereby the concentration of phenols is reduced.

The filter layer described above can also be used to restore the aroma of wine that comes from vines that have been affected by smoke. Smoked vines are vines that have been affected by fire damage.

Furthermore, the filter layer described above can be used to remove pesticides.

A process according to the invention for producing a filter layer as described above comprises at least the following steps.

Cellulose fibres and cellulose ester particles, preferably cellulose acetate propionate particles, and/or cellulose ester fibres, preferably cellulose acetate fibres, can be introduced into a pulper. The pulper can be a high-performance stirrer.

Alternatively, the cellulose ester particles and/or cellulose ester fibres are suspended in water and mixed with cellulose and, if necessary, other ingredients before the so-called ‘wet end’ of a paper machine. Mixing is preferred for at least five minutes.

A filter aid such as perlite or diatomaceous earth, for example in a concentration of 10-60 g/l, can be stirred in first, and then the adsorbent, for example in a concentration of 20-120 g/l. The stirring time can be 5-20 minutes.

Cellulose ester fibres can be incorporated into refined cellulose fibres.

The cellulose ester particles and/or cellulose ester fibres account for between 15% and 60%, preferably between 20% and 35%, by weight of the entire filter layer mixture.

At least 80% of the cellulose ester particles have a diameter between 5 μm and 300 μm, preferably between 10 μm and 100 μm. At least 80% of the cellulose ester fibres have a fibre length of 0.5 mm-5 mm and a greatest external diameter of 10 μm to 200 μm.

Subsequently, a dewatering, in particular on a fourdrinier paper machine, and a drying take place.

The cellulose ester particles and/or the cellulose ester fibres are embedded in a matrix of cellulose fibres by the process.

A process according to the invention for removing phenols from wine contaminated with Brettanomyces comprises at least the step of passing at least once through at least one filter layer as described above. The contaminated wine can also be passed through several times.

The contaminated wine can be passed at least twice through a filter system comprising at least one filter layer.

The wine can be passed through the at least one filter layer at a rate of 100 to 200 l/(m²*h).

The invention is explained below with reference to figures illustrating examples, without limiting the subject-matter of the invention to the examples shown.

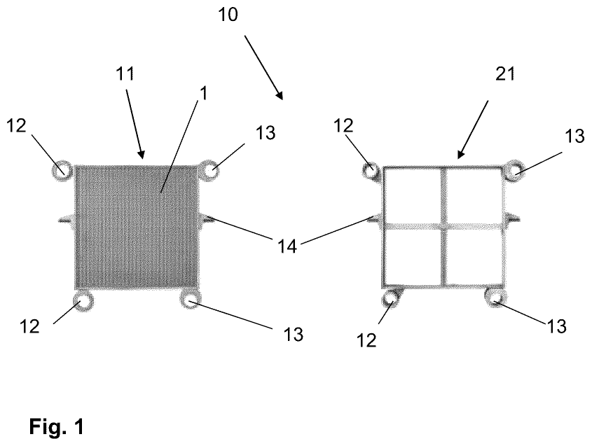

FIG. 1 shows an example of a filter element with a filter layer and a trub frame;

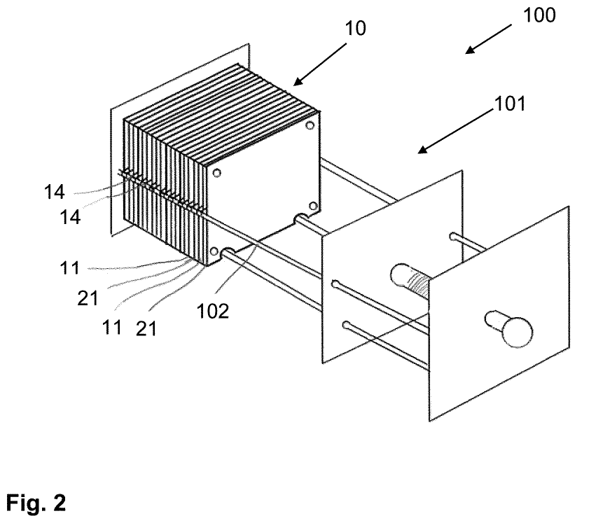

FIG. 2 shows a schematic representation of a filter system;

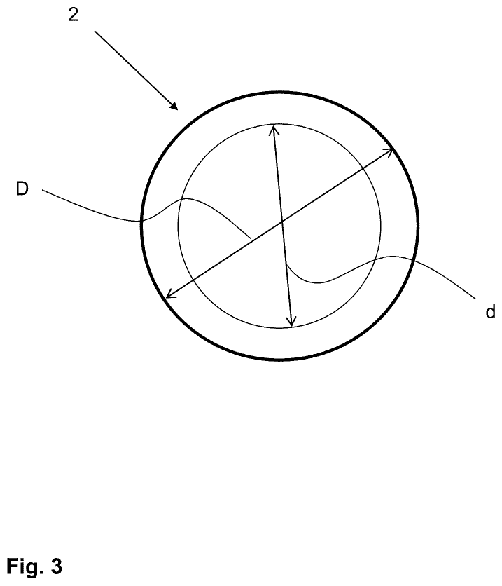

FIG. 3 shows a schematic representation of a cellulose ester fibre.

FIG. 1 shows an example of a filter element 10 comprising a clear element 11 with a filter layer 1 and a cloudy element 21.

The filter layer 1 is used between the clear element 11 and the cloudy element 21. The filter layer 1 can be attached to one of the elements 11, 21, or it can be clamped between the clear element 11 and the cloudy element 21 when the elements 11, 21 are driven together in the filter system 100 (see FIG. 2).

The typical dimensions of a filter layer 1 are, for example, 40 cm×40 cm.

A filter layer 1 can, for example, have proportions by weight
of 7-10%, in particular 8-9%, of hardwood cellulose, for example with fibre lengths in the mm range;
20-30%, in particular 23-27%, of softwood cellulose, for example with fibre lengths in the mm range;
12-18%, in particular 14-16%, of kieselguhr, for example with particle sizes between 2 μm and 130 μm;
3-10%, in particular 4-7%, of perlite,
6-10%, in particular 7.5-8.5%, of wet strength agent,
3-8%, in particular 4-5%, of aluminosilicate, and can have
an adsorbent with a weight content between 20% and 55%.

The adsorbent may be a cellulose acetate propionate powder having a degree of esterification of 45%, the 80% of the particles having a particle size between 123 and 175 μm. The powder may be incorporated at 29 to 34% by weight of all ingredients.

The adsorbent may be cellulose acetate fibres with a degree of esterification of 40% and a fibre weight of 1.5 den, the fibres having an average fibre length of 3 mm. The fibres may be embedded at a weight fraction of 20 to 30% of all components.

The adsorbent may be cellulose acetate fibres having a fibre weight of 2.5 denier, the fibres having a mean fibre length of 1.5 mm. The fibres may be embedded at 20 to 30% by weight of all components.

The adsorbent may be cellulose acetate hollow fibres of 21 denier fibre weight, the fibres having an average fibre length of 1 mm. The fibres may be embedded at 20 to 26% by weight of the other components.

The trub element 21 has openings 12 for the supply of unfiltrate and the clear element 11 has openings 13 for the discharge of filtrate. The clear element 11 and the trub element 21 also have holding elements 14.

The unfiltered material is supplied via an upper and a lower opening 12 of the cloudy element 21 and the filtered material is discharged via an upper and a lower opening 13 of the clear element 11. The filtrate therefore flows sideways.

Filter elements 10 can be assembled in a known manner in a filter system 100, as shown schematically in FIG. 2. The clear elements 11 are arranged alternately with the cloudy elements 21 on a frame 101, with the holding elements 14 resting on frame rods 102.

The unfiltered liquid is pumped into the filter system 100 and fills the cloudy elements 21. The pressure difference between the filtrate and unfiltered liquid sides causes the unfiltered liquid to be pressed through the filter layers 1 into the clear elements 11. The filtrate is then discharged from the filter system 100.

The filter system 100 can also be used for multiple flows.

For example, contaminated wine can be filtered at a flow rate of 150 l/(m²*h) and a capacity of 300 l/m².

The contact time of the ingredients of the filter layer with the medium, in this case wine, is controlled by the flow rate, preferably by means of a pump.

The capacity or performance is a measure of the total amount absorbed by the filter layer, which is typically given in volume per unit area of filter layer. The capacity is independent of the flow rate. The capacity depends on the saturation of the adsorbent in the filter layer.

It has been found that
wine contaminated with a 4-EP content of less than 1800 μg/l can be fully restored,
wine contaminated with a 4-EP content of between 1800 μg/l and 3000 μg/l can be partially restored,
in the case of wine contaminated with a 4-EP content of more than 4000 μg/l, the Brett taste can be removed, but the wine character is not fully restored.

FIG. 3 shows a schematic cross-section of a cellulose ester fibre 2, which can be embedded as an adsorbent in a filter layer 1 (see FIG. 1).

The largest external diameter D has a length of about 10 μm. The largest internal diameter d is about 70%-80% of the largest external diameter D. In contrast to a solid fibre, the hollow fibre 2 results in a higher porosity and offers a considerably larger surface.

1-13. (canceled)

14. A filter layer containing a fibrous material matrix, and an adsorbent embedded in the fibrous material matrix for the targeted removal of substances that impair taste from fluid media,
wherein the adsorbent has a proportion by weight between 10% and 60%, and the adsorbent contains at least one of
cellulose ester particles, wherein at least 80% of the particles having a diameter of less than 300 μm, and
cellulose ester fibres, where at least 80% of the fibres have a fibre length of 0.5-5 mm, and a greatest external diameter of from 10 μm to 200 μm.

15. The filter layer according to claim 14, wherein the fibrous material matrix, comprises fibres made of cellulose.

16. The filter layer according to claim 14, wherein the cellulose ester particles are cellulose acetate propionate particles.

17. The filter layer according to claim 14, wherein the thickness of the filter layer is 1-5 mm.

18. The filter layer according to claim 14, wherein the weight per unit area of the filter layer is 1000-1800 g/m².

19. The filter layer according to claim 14, wherein the water value of the filter layer at 1 bar differential pressure is 50-600 l/(m²*min).

20. The filter layer according to claim 14, wherein the adsorbent contains cellulose ester hollow fibres.

21. The filter layer according to claim 20, wherein the adsorbent contains cellulose acetate hollow fibres.

22. The filter layer according to claim 21, wherein the largest internal diameter of the cellulose ester hollow fibre is between 40% and 80% of the largest external diameter.

23. The filter layer according to claim 14, wherein the filter layer contains further ingredients, namely at least one of kieselguhr, perlite, wet strength agent and aluminosilicate.

24. The filter layer according to claim 14, wherein the adsorbent has a fibre weight greater than 3 den.

25. A filter system having at least one filter element which has at least one filter layer according to claim 14.

26. A method for removal of phenols from wine, wherein a filter layer according to claim 14 is used for the removal of phenols from wine.

27. A method for producing a filter layer according to claim 14, comprising the steps of
introducing cellulose fibres and at least one of cellulose ester particles and cellulose ester fibres into a pulper, draining and drying.

28. The method according to claim 27, wherein the cellulose ester particles are cellulose acetate propionate particles.

29. The method according to claim 27, wherein the cellulose ester fibres are cellulose acetate fibres.

30. A process for removing phenols from wine contaminated with Brettanomyces, comprising the step of passing at least once through at least one filter layer according to one of claims 14.

31. The process according to claim 30, wherein the wine is passed through the at least one filter layer at a rate of from 100 l/(m²*h) to 200 l/(m²*h).
